(19) United States
(12) Patent Application Publication
(10) Pub. No.: US 2024/0338639 A1
(43) Pub. Date: Oct. 10, 2024

(54) SYSTEM AND METHOD FOR ASSESSING WORKER JOB PERFORMANCE FITNESS

(71) Applicant: SAUDI ARABIAN OIL COMPANY, Dhahran (SA)

(72) Inventors: Turki G. AL ZAHRANI, Udhailiyah (SA); Bashar Y. MELHEM, Abqaiq (SA)

(73) Assignee: SAUDI ARABIAN OIL COMPANY, Dhahran (SA)

(21) Appl. No.: 18/298,176

(22) Filed: Apr. 10, 2023

(51) Int. Cl. G06Q 10/0639; G06Q 10/0631

(52) U.S. Cl. CPC G06Q 10/06398; G06Q 10/063114

(57) ABSTRACT

An integrated analytical model assesses the ability and fitness of a field worker to take on critical plant jobs or tasks. The inputs to the model include data about the worker's level of experience, competency, physical condition, workload, medical history, stress level as well as a live feed of health data obtained from devices worn by the worker. This data is fed into a machine learning model to assess the worker's ability to conduct work as well as the risk level to people or equipment or operations, serving as a tool to protect workers and assets. The model also provides root causes analysis for not assigning the task to the worker and recommends corrective actions.

### FIELD OF THE DISCLOSURE

The present disclosure relates generally to a system for assessing worker job performance fitness, and for example worker readiness to conduct critical field work, based on factors such as their experience, physical condition, stress levels, workload, competency, realtime health data from wearables or other sources.

### BACKGROUND OF THE DISCLOSURE

Working in oil and gas facilities and other demanding environments is challenging and requires high levels of physical fitness as well as mental and cognitive capabilities. The facilities are often located in remote areas with extreme weather and other hostile conditions that exacerbate the potential of worker stress and even breakdown. In addition, the facilities are industrial environments with heavy machinery and equipment that requires physical strength and fitness to operate. Personnel also must be fully alert and capable of quickly responding to dynamic situations calling upon rapid, rational decision-making capabilities and quick action in order to avert potential disasters.

There is a need to provide a real-time assessment of personnel fitness in demanding environments, so that remediative measures can be taken to prevent accidents that may cause injury to the monitored individual or to those in the vicinity, or cause plant damage and disruption. Measures can include pulling a worker off a job so that he/she can rest and recover, and replacing him/her with a more fit or rested individual.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, method for assessing worker job performance fitness includes receiving input about a worker, the input including discrete data relating to one or more of worker experience, worker physical fitness condition, and worker workload, and live data relating to a worker real-time physiological condition. The method further includes applying an AI model using natural language and decision tree processing to the received input, and reporting a worker fitness assessment based on the AI model, wherein the worker fitness assessment relates to one or more of classification of worker stress level, overall fitness of the worker, and fitness for a particular task.

In another embodiment, a system includes memory to store computer executable instructions, and one or more processors, operatively coupled to the memory, that execute the computer executable instructions to implement an analyzer having an input for receiving discrete data relating to one or more of worker experience, worker physical fitness condition, and worker workload, and for receiving live data relating to a worker real-time physiological condition. The analyzer also has an AI engine that uses an AI model applying natural language and decision tree processing to the input received by the analyzer and a report generator for generating a report of a worker fitness assessment that relates to one or more of classification of worker stress level, overall fitness of the worker, and fitness for a particular task.

### BRIEF DESCRIPTION OF THE DRAWINGS

FIG. 1 is a schematic diagram of a system for assessing worker job performance fitness in accordance with certain embodiments.

FIG. 2 is an example of a system for assessing worker job performance fitness in accordance with certain embodiments.

FIG. 3 is a flow diagram of a method for assessing worker job performance fitness in accordance with certain embodiments.

FIG. 4 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to the use of an artificial intelligence (AI) model that can, in real time, provide a worker job performance indicator. The worker job performance indicator can relate to worker fitness or healthiness, including for example worker risk/stress level and preparedness for performance of one or more of various tasks in a plant such as an oil and gas facility. The model can be fed live data as well as discrete data. The live data can be from a wearable component worn by each plant worker involved in demanding jobs (example plant Turnaround and Inspection). The live data can include input including but not limited to, sleep hours, heart rate, exercise hours, etc. The discrete data can include results from medical health checks, medical history, workload, years of experience, etc. The output of the model can include a stress level indicator and a risk level that can be used for example to qualify or disqualify the worker from conducting certain high risk and extremely demanding tasks.

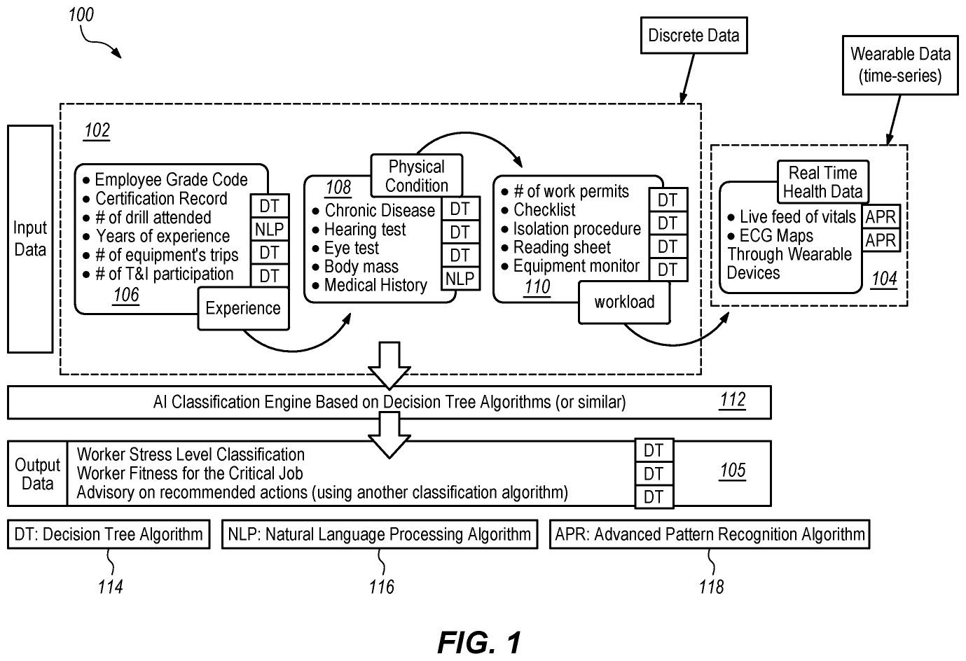

FIG. 1 is a schematic diagram of a system 100 for assessing worker job performance fitness, for example for performing tasks in a particular environment such as an oil and gas plant. Inputs to the system 100 comprise discrete data 102 and live (e.g. wearable or real-time) data 104. Outputs 105 of the system 100 include one or more of indicators or classifications of worker stress level, overall fitness of the worker and/or fitness for a particular task or tasks, advisories on recommended actions, warnings, or remediations, or indicators of qualification or disqualification of the worker from one or more tasks, shifts, etc.

Discrete data 102 that is input into system 100 includes such information as worker experience 106, worker physical fitness and/or medical condition 108, and worker workload 110. Live data 104 relates to the worker's real-time physiological condition, as gleaned for example from a wearable device (not shown) or the like that can for instance provide pulse rate and cardio rhythms and patterns and other heart information, worker temperature, blood glucose level, skin moisture and hydration, sleep time, exercise time and level, and any other parameters that may be monitored in real-time and that may be relevant for determining that particular worker's physical and/or mental state, and fitness for a particular task or tasks.

In contrast to live data 104, discrete data 102 about a worker may be acquired and stored “offline,” as compared to in real time. For example, it may be pre-gathered and stored in a data base (not shown) for access by system 100 for conducting its work assessment.

As mentioned above, discrete data 102 includes worker experience 106, worker physical fitness condition 108, and worker workload 110. Worker experience 106 can relate to one or more of:
Employee Grade Code, which may be a company designation representative of factors such as general and specific experience, education, rank, company department, and so on.
Certification record, which may represent official qualifications and certifications of the worker
Number of Drills Attended, reflecting practice actions and behaviors in connection with specific scenarios
Number of Equipment Trips, reflecting number of equipment that tripped or failed under the watch of the particular worker.
Number of T&I Participation. The higher the number of Turnaround and Inspection jobs the worker participates in, the higher is their competency and experience level

Worker physical fitness condition 108 can relate to factors such as individual and family medical history, chronic disease, hearing or vision or other sensory deficits or impairments, body mass and general physical fitness, physical disabilities, and any other relevant personal or family medical history conditions or the like.

Worker workload 110 can relate to the number of permits the worker currently has, worker checklist, number of work tickets, any isolation procedures to which the worker is currently subject, reading sheet, and equipment monitor. For example, plant workers may be granted a certain number of work permits by the foreman or permit issuers. A high number of average permits indicates that the worker is in high demand but would also indicate an increased workload and possibly elevated work stress level. The same applies for the number of checklists the worker is assigned; a checklist is where equipment daily test data is kept.

System 100 includes an analysis module 112 operable to consider the discrete data 102 and the live data 104 received as inputs and to generate system outputs 105, which may be one or more of indicators of worker stress level, overall fitness of the worker and/or fitness for particular tasks, and advisories on recommended actions, warnings, or remediations, as mentioned above.

In certain embodiments, analysis module 112 can build an AI (artificial intelligence) model implementing an AI classification algorithm such as a decision tree algorithm or other AI techniques for facilitating the decision process about the worker's stress level, fitness and remediation recommendations as functions of system inputs 102 (discrete data) and 104 (live data).

System 100 implements AI processes at other stages in its operation besides in the analysis module 112. These can include a decision tree (DT) algorithm 114, a natural language processing (NLP) algorithm 116, and an advanced pattern recognition (APR) algorithm 118 that may be applied at the various inputs to the system. For instance, the decision tree (DT) algorithm 114 and the natural language processing (NLP) algorithm 116 can be applied at the experience (106), physical condition (108) and workload inputs (110), and the advanced pattern recognition (APR) algorithm 118 can be applied at the live data input 104.

In certain embodiments, the natural language processing (NLP) 116 can utilize an algorithm that classifies data residing in narratives, reports and different types of text documents and information into model inputs. Natural language processing (NLP) may be divided into functionality for natural language understanding (NLU) (or natural language interpretation (NLI)), and natural language generation (NLG). Natural language understanding (NLU) (or natural language interpretation (NLI)) includes various operations that implement text classification for use in an automated analysis of unstructured data, e.g., to determine classified health data. For example, an NLU operation may use a large vocabulary to analyze discrete data 102 text strings with diverse syntax to determine health risk information. On the other hand, a natural language generation (NLG) operation may simulate the human ability to create natural language text to identify labels for one or more plant hazards associated with text from an unstructured data source. NLP operations 116 may transform internal and external document formats (e.g. HTML, Word, PowerPoint, Excel, PDF text, PDF image) into a standardized searchable format for use by for example a plant health manager. A plant health manager may have the ability to identify, tag and search specific document sections to identify meaningful portions within text, and may include various semantic tools that identify health concepts within the text such as chemical elements, biological elements, and physical injuries and their respective causes.

In certain embodiments, the decision tree (DT) 114, and potentially other types of classification algorithms used herein, can operate to classify the output of the NLP model 116 plus the discrete data 102 (such as medical history, etc. plus industrial data) plus the live data 104 (provided through wearables for example) into worker health risk level or the like as an example output 105. For example, different types of machine-learning models may be trained, such as convolutional neural networks, deep neural networks, recurrent neural networks, support vector machines, decision trees, inductive learning models, deductive learning models, supervised learning models, unsupervised learning models, reinforcement learning models, etc. In some embodiments, two or more different types of machine-learning models are integrated into a single machine-learning architecture, e.g., a machine-learning model may include support vector machines and neural networks. In some embodiments, the plant health manager or other stakeholder may generate augmented data or synthetic data to produce a large amount of interpreted data for training a particular model. In certain embodiments, the AI algorithms can be trained using past incidents of personnel breakdowns, underperformance and other anomalies/risks. Advanced pattern recognition (APR) 118 can be used to analyze time series data for anomalies. The anomalies may be for example irregular heart rate or other type of irregularities in the time-series read from the wearables, etc. S suitable machine learning algorithm to detect such anomalies is the advanced pattern recognition (APR). Other anomaly detection algorithms can be referenced, e.g. Principal Component Analysis (PCA), Support Vector Machine (SVM), Local Outliar Factor (LOF), and so on, without departing from the spirit and scope of the disclosure.

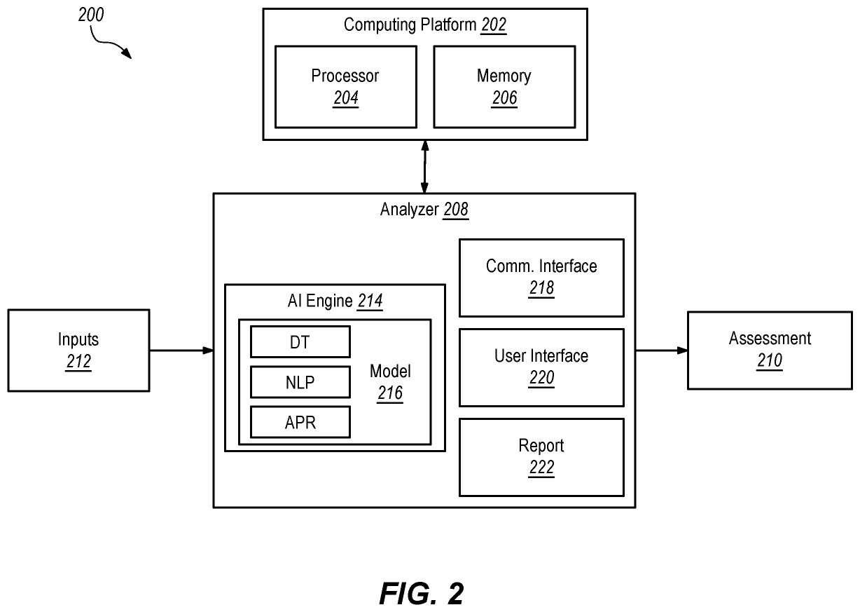

FIG. 2 is an example of a system 200 for assessing worker job performance fitness in accordance with certain embodiments. The system 200 can be implemented using one or more modules, shown in block form. The one or more modules can be in software or hardware form, or a combination thereof. In some examples, one or more portions of the system 200 can be implemented as machine readable instructions for execution on a computing platform 202 having a processor 204 and a memory 206.

The system 200 includes an analyzer 208 that is operable to provide an assessment report 210 based on received data inputs 212. The inputs 212 may correspond to the discrete data 102 and live (real-time or wearable) data 104 described above, and the assessment report 210 may correspond to the output 105 relating to the one or more of classification of worker stress level, overall fitness of the worker and/or fitness for particular tasks, and advisories on recommended actions, warnings, or remediations also described above. The advisories can be qualifications or disqualifications from tasks or work shifts, and in certain embodiments may include indications of stress level and risk level. In certain embodiments, they can include work environment improvement suggestions, such as more training, operator simulation training (OTS), which is an operations simulator that includes various what-if scenarios and measures how the worker addresses each and is based on process simulation models, or conducting more or frequent drills. In certain embodiments, worker health related alerts can be generated, such as may be necessary in the presence of increased pulse rate, potential heart attack symptoms, onset of dehydration, and so on.

The computing platform 202 can include one or more computing devices selected from, for example, a desktop computer, a server, a controller, a blade, a mobile phone, a tablet, a laptop, a personal digital assistant (PDA), and the like. By way of example, the memory 206 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 204 can be implemented, for example, as one or more processor cores. The memory 206 can store machine-readable instructions (e.g., which can include the analyzer 208) that can be retrieved and executed by the processor 204. Each of the processor 204 and the memory 206 can be implemented on a similar or a different computing platform. The computing platform 202 can be implemented in a cloud computing environment. In such a situation, features of the computing platform 202 can be representative of a single instance of hardware or multiple instances of hardware executing across the multiple of instances (e.g., distributed) of hardware (e.g., computers, routers, memory, processors, or a combination thereof). Alternatively, the computing platform 202 can be implemented on a single dedicated server or workstation.

Analyzer 208 includes an AI engine 214 implementing for example AI model 216 using the decision tree (DT) algorithm 114, natural language processing (NLP) algorithm 116, and advanced pattern recognition (APR) algorithm 118 as described above in connection with FIG. 1. Input data 212 can be processed as inputs through AI model 216 to monitor the health and stress level of the worker and so on as described above. The AI model 216 can provide the optimum manpower requirements to execute critical activities, considering the human error factor and response rate such as emergency shutdown, system isolation, respond to emergency and Test & Inspection activities. The AI model 216 can provide a recommendation to improve the work environment like more training, operator simulation training (OTS), and more frequent drills. In certain embodiments, model 216 can perform perspective analytics, whereby similarities are drawn between current trends and past incidents to give insights about the future; which worker is more susceptible to what type of risk and how were similar cases were addressed. It will be appreciated that perspective analytics is a type of data analytics that identifies the root cause of an issue or recommendations to fix it based on past historic data of similar issues/incidents.

Analyzer 208 further includes communication interface 218 configured to receive information corresponding to input data 212, and to deliver information corresponding to the assessment report 210; and a user interface 220 that allows a user, such as an administrator or health manager, to adjust operational parameters of the system 200, and read displayed information by the system. A report generator 222 generates the assessment report 210 corresponding to the output 105 relating to the one or more of classification of worker stress level, overall fitness of the worker and/or fitness for particular tasks, and advisories on recommended actions, warnings, or remediations as set forth above.

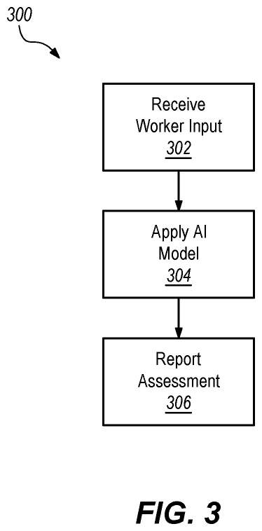

In view of the structural and functional features described above, an example method will be better appreciated with reference to FIG. 3. While, for purposes of simplicity of explanation, the example method of FIG. 3 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the method, and conversely, some actions may be performed that are omitted from the description.

FIG. 3 is a flow diagram of a method 300 for assessing worker job performance fitness in accordance with certain embodiments. The method includes receiving, at 302, input about a worker. The input can include discrete data (e.g. discrete data 102, FIG. 1) relating to one or more of worker experience, worker physical fitness condition, and worker workload, and live data (e.g. live data 104, FIG. 1) relating to a worker real-time physiological condition. At 304, an AI model (e.g. AI model 216, FIG. 2) using natural language and decision tree processing is applied to the received input. At 306, a worker fitness assessment based on the AI model is reported, wherein the worker assessment (e.g. assessment 210, FIG. 2) relates to one or more of classification of worker stress level, overall fitness of the worker, and fitness for a particular task.

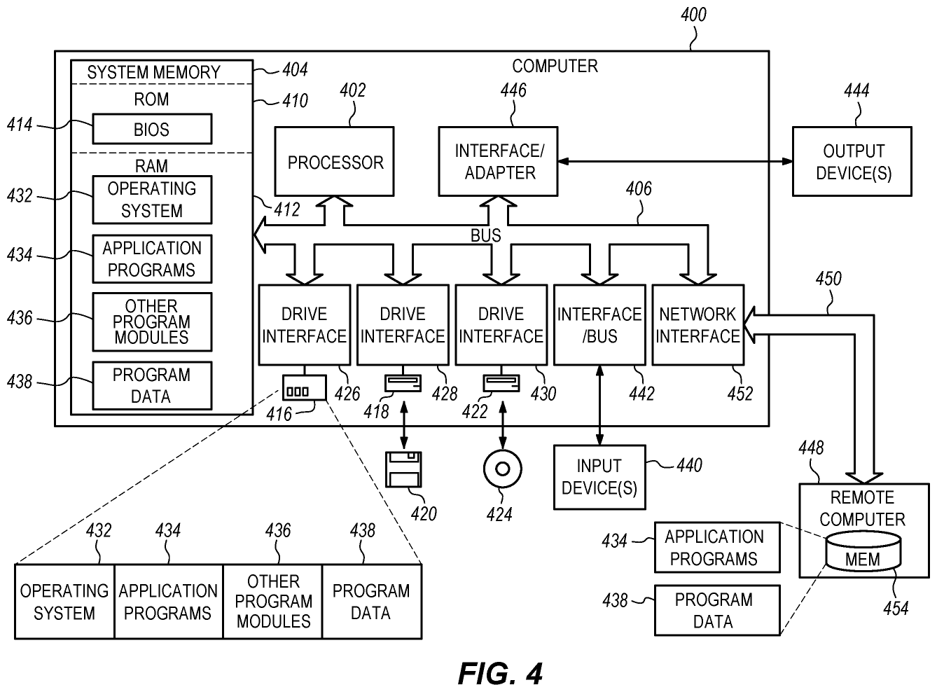

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include analyzer 208 and/or any of its component modules, and the program data 438 can include discrete data 102 and live data 104, as well as the assessment 210. The application programs 434 and program data 438 can include functions and methods programmed to apply the AI model 216 using natural language and decision tree processing to the discrete (102) and live (104) data, and to report a worker fitness assessment based on the AI model, wherein the worker fitness assessment relates to one or more of classification of worker stress level, overall fitness of the worker, and fitness for a particular task, such as shown and described herein.

A user may enter commands and information into computer system 400 through one or more input devices 440, such as a pointing device (e.g., a mouse, touch screen), keyboard, microphone, joystick, game pad, scanner, and the like. These can correspond to user interface 220 (FIG. 2) for instance. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 300, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for assessing worker job performance fitness comprising:
receiving input about a worker, the input including:
discrete data relating to one or more of worker experience, worker physical fitness condition, and worker workload, and
live data relating to a worker real-time physiological condition;
applying an AI model using natural language and decision tree processing to the received input; and
reporting a worker fitness assessment based on the AI model, wherein the worker fitness assessment relates to one or more of classification of worker stress level, overall fitness of the worker, and fitness for a particular task.

2. The method of claim 1, wherein the discrete data comprises one or more of worker experience, worker physical fitness condition, and worker workload.

3. The method of claim 2, wherein the worker experience relates to one or more of:
Employee Grade Code,
Certification record,
Number of Drills Attended,
Number of Equipment Trips, and
Number of T&I Participation.

4. The method of claim 1, wherein the live data is obtained at least partially from a wearable device.

5. The method of claim 1, wherein the live data relates to one or more of pulse rate, cardio rhythms, cardio patterns, worker temperature, blood glucose level, skin moisture and hydration, sleep time, and exercise time and level.

6. The method of claim 1, wherein applying the AI model further comprises using advanced pattern recognition to analyze time series data for anomalies.

7. The method of claim 1, further comprising generating an advisory on recommended actions, warnings, or remediations.

8. The method of claim 7 wherein the advisory includes one or of:
a qualification or disqualification from a task or shift, tasks or work shifts, an indication of stress level, health condition or risk level of the worker, and work environment improvement suggestions.

9. A system, comprising:
memory to store computer executable instructions; and
one or more processors, operatively coupled to the memory, that execute the computer executable instructions to implement:
an analyzer having:
an input for receiving discrete data relating to one or more of worker experience, worker physical fitness condition, and worker workload, and for receiving live data relating to a worker real-time physiological condition;
an AI engine that uses an AI model applying natural language and decision tree processing to the input received by the analyzer; and
a report generator for generating a report of a worker fitness assessment that relates to one or more of classification of worker stress level, overall fitness of the worker, and fitness for a particular task.

10. The system of claim 9, wherein the discrete data comprises one or more of worker experience, worker physical fitness condition, and worker workload.

11. The system of claim 10, wherein the worker experience relates to one or more of:
Employee Grade Code,
Certification record,
Number of Drills Attended,
Number of Equipment Trips, and
Number of T&I Participation.

12. The system of claim 9, wherein the live data is obtained at least partially from a wearable device.

13. The system of claim 9, wherein the live data relates to one or more of pulse rate, cardio rhythms, cardio patterns, worker temperature, blood glucose level, skin moisture and hydration, sleep time, and exercise time and level.

14. The system of claim 9, wherein the AI model further applies advanced pattern recognition to analyze time series data for anomalies.

15. The system of claim 9, wherein the report generator generates an advisory on recommended actions, warnings, or remediations.

16. The system of claim 15, wherein the advisory includes one or of:
a qualification or disqualification from a task or shift, tasks or work shifts,
an indication of stress level, health condition or risk level of the worker, and
work environment improvement suggestions.
